(19) United States
(12) Patent Application Publication
(10) Pub. No.: US 2025/0137724 A1
(43) Pub. Date: May 1, 2025

(54) COOLING ELEMENT AND A METHOD IN CONNECTION WITH A COOLING ELEMENT

(71) Applicant: METSO METALS OY, Espoo (FI)

(72) Inventors: Peter BJÖRKLUND, Espoo (FI); Valtteri SONNINEN, Kauniainen (FI); Tiina RANKI, Espoo (FI); Jaana ROMPPANEN, Espoo (FI); Aki LAANINEN, Kirkkonummi (FI); Heikki HEINONEN, Helsinki (FI); Petri SOLA, Espoo (FI); Päivi SUIKKANEN, Pori (FI)

(21) Appl. No.: 18/689,454

(22) PCT Filed: Sep. 10, 2021
(86) PCT No.: PCT/FI2021/050603

§ 371 Date: Mar. 6, 2024

(51) Int. Cl. F27D 1/12; F27D 9/00; F27D 21/00

(52) U.S. Cl. CPC F27D 1/12; F27D 2009/0018; F27D 2021/0007

(57) ABSTRACT

A cooling element for a furnace includes a first side configured to be directed towards the inside of the furnace, a second side opposite to the first side and configured to be directed away from the inside of the furnace, and a cooling fluid channel system for cooling fluid circulation. The cooling element further includes a monitoring channel system including at least one monitoring channel for pressure medium. At least a portion of the monitoring channel extends in a portion of the cooling element provided between the first side and a plane defined by the points of the cooling fluid channel system closest to the first side.

### BACKGROUND

The disclosure relates to furnaces, and more particularly to a cooling element of a furnace. The present disclosure further concerns a method in connection with such a cooling element.

In connection with furnaces used for industrial purposes, particularly in the manufacturing of metals, such as flash smelting furnaces, blast furnaces and electric furnaces or other metallurgic reactors, there are used cooling elements. Cooling elements are typically made of mainly copper due to its good thermal conductivity. Typically, these cooling elements are cooled by water and thus provided with a cooling water channel system, in which case the heat is transferred from the fire-resistant bricks in the furnace space, via the housing of the cooling element, to the cooling water. The working conditions are extreme, and the cooling elements are subjected, among other things, to strong corrosion and erosion strains caused by the furnace atmosphere or molten contacts. Over time, wear and damages may occur in the cooling element. If the damages reach the cooling water channel system, the cooling water may leak out to the inside of the furnace, which may lead to process failures, unplanned service breaks and remarkable economic losses.

### BRIEF DESCRIPTION OF THE DISCLOSURE

An object of the present disclosure is to provide a new cooling element and a new method in connection with a cooling element. The object is achieved by a method and a cooling element, which are characterized by what is stated in the independent claims. Some preferred embodiments of the disclosure are disclosed in the dependent claims.

The disclosure is based on the idea of providing a monitoring channel system inside the cooling element. More particularly, a monitoring channel system is provided inside the cooling element between cooling fluid channel system and the surface facing towards the inside of the furnace, when the cooling element is mounted to the furnace for use.

An advantage of the method and arrangement of the disclosure is that wear in the cooling element can be detected before the possible damages reach the cooling fluid channel system. This way needs for repairing or replacing the cooling elements can be predicted and process downtime can be planned and optimized with other maintenance needs. Furthermore, the disclosure provides an effective monitoring arrangement with a simple structure and less components and wiring than in known solutions.

### BRIEF DESCRIPTION OF THE DRAWINGS

In the following the disclosure will be described in greater detail by means of preferred embodiments with reference to the accompanying drawings, in which

FIG. 1 illustrates a cross-section of a detail of a furnace;

FIG. 2 illustrates schematically a cooling element according to an embodiment in a cross-section;

FIG. 3 illustrates schematically a cooling element according to an embodiment in a cross-section from a direction perpendicular to that of FIG. 2;

FIG. 4 illustrates a plane defined by the points of the cooling fluid channel closest to the first side according to an embodiment; and

FIG. 5 illustrates a plane defined by the points of the cooling fluid channel closest to the first side according to another embodiment;

FIG. 6 illustrates schematically an angle between a plane defined by the points of the cooling fluid channel closest to the first side and a monitoring channel;

FIG. 7 illustrates schematically a cooling element in cross section seen from an end of the cooling element;

FIG. 8 illustrates schematically the cooling element of FIG. 7 in magnified cross section seen in the direction B-B of intersection shown in FIG. 7;

FIG. 9 illustrates schematically a cooling element in cross section seen from an end of the cooling element;

FIG. 10 illustrates schematically the cooling element of FIG. 9 in magnified cross section seen in the direction of intersection B-B shown in FIG. 9;

FIG. 11 illustrates schematically a cooling element in cross section seen from an end of the cooling element;

FIG. 12 illustrates schematically the cooling element of FIG. 11 in magnified cross section seen in the direction of intersection B-B shown in FIG. 11;

FIGS. 13 and 14 illustrate schematically two different embodiments of a cooling element in cross section seen from an end of the cooling element;

FIGS. 15 to 23 illustrate schematically different embodiments of cooling elements in magnified seen in the direction of intersection C-C shown in FIG. 13 or in the direction of intersection A-A shown in FIG. 14;

FIG. 24 illustrates a cooling arrangement;

FIG. 25 illustrates a detail of a cooling arrangement according to an embodiment;

FIG. 26 illustrates a method in connection with a cooling element; and

FIG. 27 illustrates a method for monitoring wear of a cooling element for a furnace.

The drawings are provided for illustrative purposes only, whereby they are not shown to scale and not all the corresponding features are provided with

### DETAILED DESCRIPTION

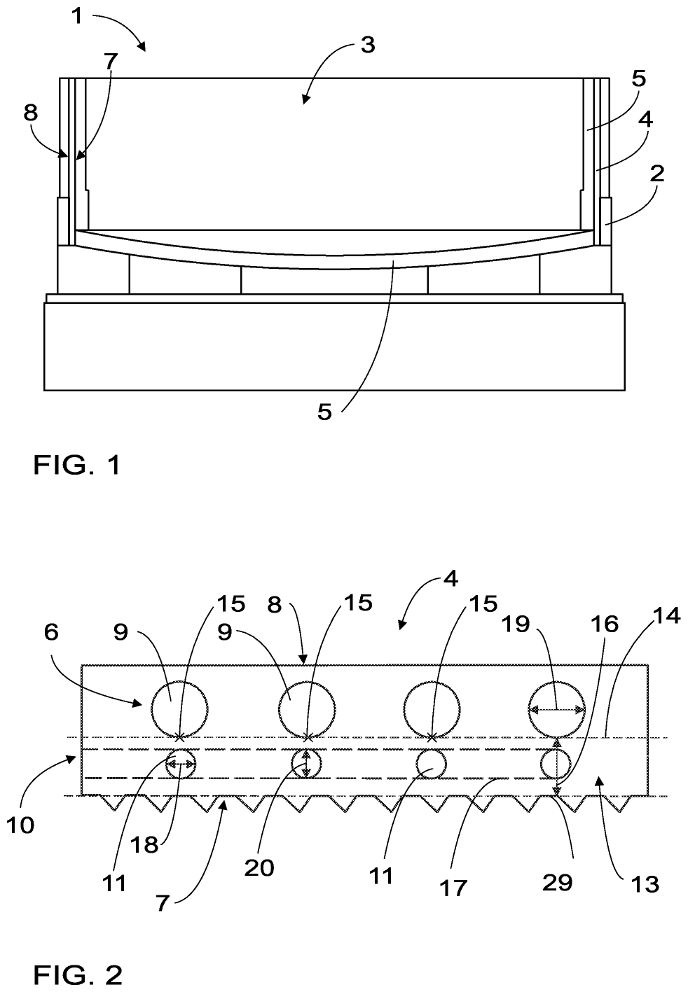

FIG. 1 illustrates a cross-section of a detail of a furnace 1. It is clear for a person skilled in the art that the furnace shown in FIG. 1 is just an example of different types of furnaces, in which cooling elements and methods disclosed in this description and accompanying drawings may be used, and shown to illustrate some relevant terms and features typical for such furnaces. Similarly, it is clear for a person skilled in the art that such a furnace comprises a plurality of parts and structures not mentioned in this description, because they are not relevant regarding the solution in question.

A furnace 1 typically comprises a furnace housing 2 and inside the furnace housing a furnace space, in other words an inside 3 of the furnace, within which the material to be processed can be provided. According to an embodiment, the furnace 1 is used for industrial purposes. According to an embodiment, the furnace is more particularly used in manufacturing of metals. Such a furnace 1 may comprise a flash smelting furnace, a blast furnace, an electric furnace or another type of a metallurgic reactor.

Typically, furnaces of the above-mentioned types, such as the furnace of FIG. 1, comprise cooling elements 4 provided on the side of the furnace housing 2 directed towards the inside 3 of the furnace. Depending on the embodiment, one or more of cooling elements 4 disclosed in this description may be provided at different parts of the furnace 1. The cooling elements 4 may surround the inside 3 of the furnace entirely, one or more cooling elements 4 may be provided to cover a part of the furnace housing 2 or one or more cooling elements 4 may be provided at specific spot(s) of the furnace 1 only, where cooling is needed. As an example, in embodiments where the furnace 1 comprises a flash smelting furnace, one or more cooling elements 4 may be provided in reaction chamber, in lower furnace, settler and/or in uptake shaft. According to a further embodiment, a fireproof lining 5, for instance a lining comprising fireproof bricks, is provided in connection with surface of the cooling elements 4 directed towards the inside 3 of the furnace. The fireproof lining may comprise a ceramic material. In this description, when the expression and/or is used, it refers to at least one of the disclosed alternatives, in other words to one or more of the alternatives.

According to an embodiment, a cooling element 4 may comprise copper. According to an embodiment, at least 50 percent of the volume of a cooling element 4 may consist of copper. More preferably at least 60 percent and most preferably at least 70 percent of the volume of a cooling element 4 may consist of copper. According to an embodiment, a cooling element 4 may comprise other material(s) in addition to or instead of copper.

Cooling elements 4 may be cooled by a cooling fluid, such as a cooling liquid, circulated inside the cooling element. For this purpose, a cooling fluid channel system 6 may be provided inside the cooling element 4. Thus, the heat may be transferred from the fire-proof lining 5, via a housing of the cooling element 4, to the cooling liquid.

An advantage of embodiments, wherein the cooling element 4 comprises a high percentage of copper, such as 50, 60 or 70 percent of the volume, is that copper has particularly good thermal conductivity and, thus, the cooling element 4 can effectively transfer heat from the surface directed towards the inside 3 of the furnace, for instance from a fireproof lining 5, to the cooling fluid in the cooling fluid channel system 6. The cooling element 4 may be provided with grooves or ridges, and the fireproof lining 5 may comprise for instance ceramic members, such as fireproof bricks made of ceramic or other type of material.

FIG. 2 illustrates schematically a cooling element 4 according to an embodiment in a cross-section. A cooling element 4 for a furnace 1 comprises a first side 7 configured to be directed towards the inside 3 of the furnace, and a second side 8 opposite to the first side 7 and configured to be directed away from the inside 3 of the furnace. In other words, the first side 7 comprises the side of the cooling element 4 arranged towards the inside 3 of the furnace, also called the furnace space, and the second side 8 comprises the side of the cooling element 4 arranged towards the furnace housing 2, when the cooling element 4 is mounted to a furnace 1.

The cooling element 4 also comprises a cooling fluid channel system 6 for cooling fluid circulation. The cooling fluid channel system 6 comprises at least one cooling fluid channel 9 provided inside the cooling element 4. According to an embodiment, the cooling element 4 comprises two or more cooling fluid channels 9. Each cooling fluid channel 9 is configured to receive cooling fluid. Thus, cooling fluid circulation can be configured to take place in the cooling fluid channel system 6. Cooling fluid circulation and cooling fluid channels are known in the art and are thus not discussed here in detail.

The cooling element 4 further comprises a monitoring channel system 10. The monitoring channel system 10 comprises at least one monitoring channel 11 for pressure medium. In other words, the monitoring channel 11 is configured to receive pressure medium. Pressure and/or flow in the monitoring channel 11 can be monitored and the data can be used for monitoring a condition, such as wear, of the cooling element 4. More particularly, the data can be used to detect wear of the cooling element 4 on the first side 7 directed towards the inside 3 of the furnace 1 and is, thus, exposed to high temperatures. Monitoring the condition of the cooling element 4 is described in more detail later in connection with other embodiments. Such monitoring channel(s) 11 enable detecting wear before it reaches the cooling fluid channel(s) 9. The cooling element 4 can thereby be for instance replaced or repaired before there is a risk of the cooling fluid coming into contact with the inside 3 of the furnace 1. According to an embodiment, the monitoring channel system 10 comprises exactly one monitoring channel 11 for pressure medium.

Depending on the embodiment, cooling element 4 may be manufactured for instance by casting, such as continuous casting, mould casting or sand casting. Depending on the embodiment, the monitoring channel 11 and the monitoring channel system 10 may be formed in the cooling element 4 by machining, such as by drilling, or in connection with casting and/or moulding.

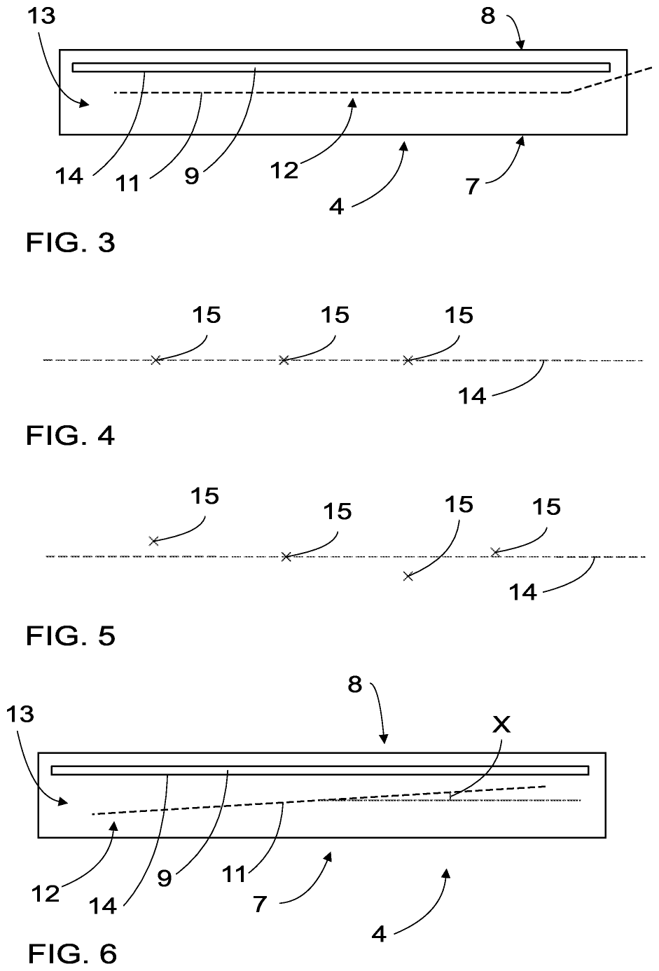

At least a portion 12 of the monitoring channel 11 extends in a portion 13 of the cooling element provided between the first side 7 and a plane 14 defined by the points 15 of the cooling fluid channel system 6 closest to the first side 7. This is shown for instance in FIG. 3 that illustrates schematically a cooling element according to an embodiment in a cross-section from a direction perpendicular to that of FIG. 2. An advantage of such embodiments is that a larger area of the cooling element 4 and the cooling fluid channel system 6 can be covered and, thus, monitored than with point-like measurement or monitoring points, for example. FIG. 3 schematically illustrates that a monitoring channel 11 may also have other portions inside and outside the cooling element 4. It is clear for a person skilled in the art that this is a schematic example only and that the monitoring channels 11 may have portions angled with respect to each other in several dimensions. Some examples are shown in the accompanying drawings. It is also clear for a person skilled in the art that the cooling fluid channel(s) 9 are not necessarily straight, but they might have a curved, waved, zigzag or some other shape. Still, they have points 15 defining the plane 14 as described in this description.

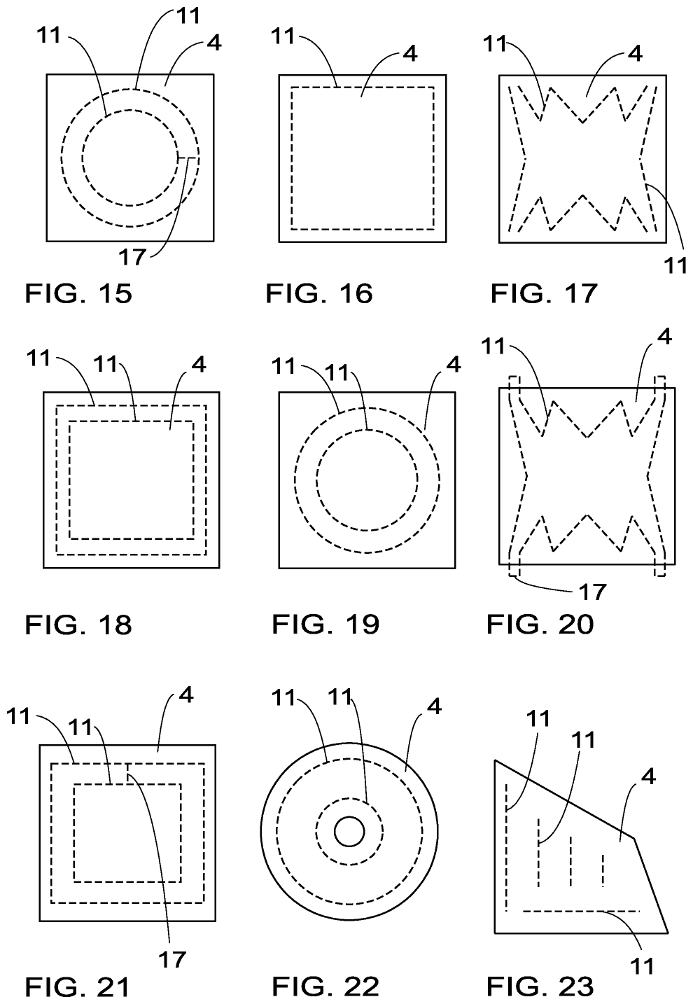

A monitoring channel 11 or some other structural feature extending in a direction or plane or within a portion refers to the structural feature having a substantial dimension in that direction or plane or within that portion. In the context of this description, for instance a straight borehole is understood to extend in the longitudinal direction of the borehole, in other words in the direction of the forward motion of the drill, but not in a direction perpendicular to the longitudinal direction, although a borehole naturally has a diameter as well. A curved monitoring channel 11, such as a monitoring channel of FIG. 15, 19 or 22, is considered to extend in the curved direction, which in the case of the monitoring channel 11 is at each point perpendicular to the cross section 18 of the monitoring channel 11. A curved feature may comprise a waved, circular or spiralled feature, such as a monitoring channel 11. Similarly, in the context of this description, a plane is considered to extend in two dimensions perpendicular to each other, but not in the third direction perpendicular to the other two. Thus, for instance the monitoring channel 11 has a dimension larger than the diameter 20 of the monitoring channel in the direction in which it is said to extend.

According to an embodiment, the dimension of the monitoring channel 11 extending in the portion 13 of the cooling element between the first side 7 and a plane 14 defined by the points 15 of the cooling fluid channel system 6 closest to the first side 7 may be at least 10 times the diameter 20 of the monitoring channel 11, and preferably at least 50 times the diameter 20 of the monitoring channel 11. According to an embodiment, the dimension of the monitoring channel 11 extending in the portion 13 of the cooling element between the first side 7 and a plane 14 defined by the points 15 of the cooling fluid channel system 6 closest to the first side 7 may be at least 70 percent of the length of a cooling fluid channel 9. According to an embodiment, the dimension of the monitoring channel 11 extending in the portion 13 of the cooling element between the first side 7 and a plane 14 defined by the points 15 of the cooling fluid channel system 6 closest to the first side 7 may be at least 1 meter long, preferably at least 4 meters long. According to an embodiment, the sum of the dimensions of the monitoring channels 11 extending in the portion 13 of the cooling element 4 between the first side 7 and a plane 14 defined by the points 15 of the cooling fluid channel system 6 closest to the first side 7 may be at least 1 meter long, preferably at least 4 meters long.

The points 15 of the cooling fluid channel system 6 closest to the first side 7 refer to three or more points of the interface between the cooling fluid channel(s) 9 of the cooling fluid channel system 6 with the shortest distance 16 from the first side 7 measured in a direction transverse to the first side 7. In other words, the shortest distance 16 is measured from the surface of the first side 7 configured to be directed towards the inside 3 of the furnace. The plane 14 defined by the points 15 of the cooling fluid channel system 6 closest to the first side 7 refers to a plane extending through all the points 15, such as illustrated in FIG. 4, or a plane defined using interpolation using the points 15 as data points, an example of which is schematically illustrated in FIG. 5. In other words, the plane 14 may comprise a plane extending through the points 15 or a close approximate representing the level of the points 15 within the cooling element 4. Thereby, at least the portion 12 of the monitoring channel 11 extends inside the cooling element 4 between the cooling fluid channel system 6 and the first side 7 of the cooling element.

The portion 12 of the monitoring channel 11 may also be called a monitoring channel portion 12 and, similarly, the portion 13 of the cooling element may also be called a cooling element portion 13 in this description. Depending on the embodiment, the monitoring channel 11 may also comprise other portions in addition to portion 12, such as a portion extending outside the cooling element 4 and/or a portion extending a direction perpendicular to the plane 14 and/or the first side 7.

According to an embodiment, the portion 12 of the monitoring channel extends in at least one of the following directions: in a direction parallel to the plane 14, in a direction parallel to at least a part of a surface of the first side 7, or in a direction provided at an angle X of 30 degrees or less, preferably 10 degrees or less, with respect to the plane 14. In other words, the monitoring channel portion 12 extends between the plane 14 and the first side 7, more particularly the surface of the first side 7 directed towards the inside 3 of the furnace, when the cooling element 4 is mounted to the furnace. More particularly, the mounting channel portion 12 in a direction angled 30 degrees or less, preferably 10 degrees or less, with respect to the plane 14 and/or in a direction parallel to at least a part of the surface of the first side 7. In practice this means that the mounting channel portion 12 extends within the cooling element 4 between the plane 14 and the first side 7 in a direction substantially parallel or slightly angled with respect to at least a part of the surface of the first side 7. An angle X between the plane 14 and the monitoring channel 11 according to an embodiment is shown in FIG. 6. In FIG. 6 a line parallel to the plane 14 is added to more clearly illustrate the angle X.

In some embodiments, such as in the embodiment of FIG. 2, the surface of the first side 7 may not be planar and/or it may consist of several sections angled with respect each other, for example. The surface of the first side 7 may be for instance ridged and/or curved. Thus, the part of the surface of the first side 7 is preferably a part of the surface of the first side at or close to the position of the monitoring channel 11 when seen from the direction of the first side 7 towards the second side 8.

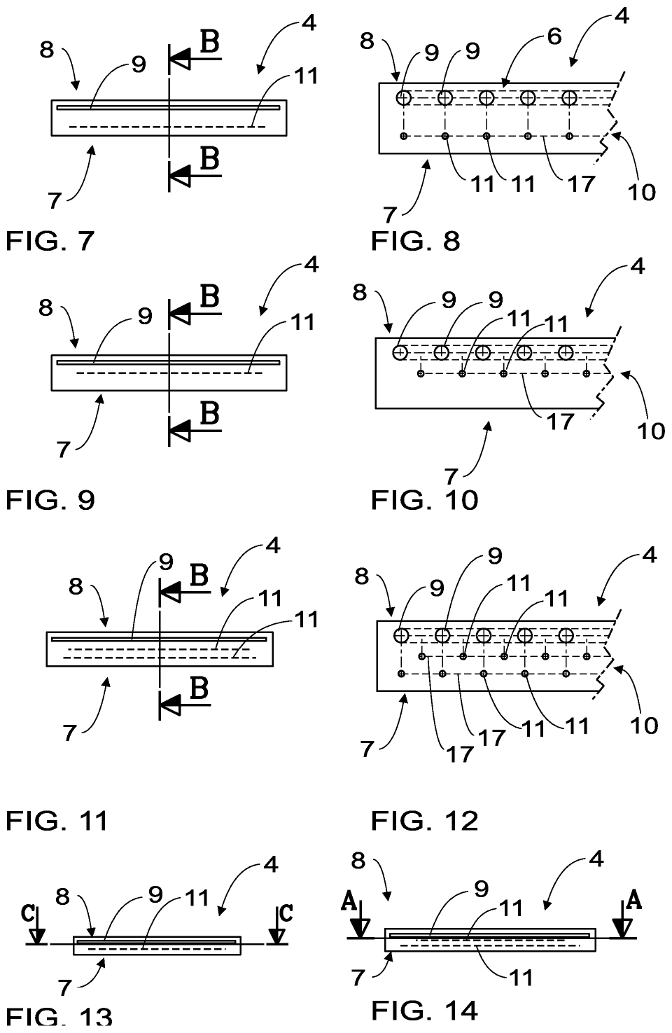

FIG. 7 illustrates schematically a cooling element 4 in cross section seen from an end of the cooling element and FIG. 8 illustrates schematically the cooling element of FIG. 7 in magnified cross section seen in the direction B-B shown in FIG. 7. Similarly, FIG. 9 illustrates schematically a cooling element 4 in cross section seen from an end of the cooling element and FIG. 10 illustrates schematically the cooling element of FIG. 9 in magnified cross section seen in the direction B-B shown in FIG. 9. Also similarly, FIG. 11 illustrates schematically a cooling element in cross section seen from an end of the cooling element and FIG. 12 illustrates schematically the cooling element of FIG. 11 in magnified cross section seen in the direction of intersection B-B shown in FIG. 11.

According to an embodiment, such as the embodiment of FIG. 13, the one or more monitoring channels 11 may be provided in one plane. According to another embodiment, such as the embodiment of FIG. 14, monitoring channels 11 may be provided in two or more planes. Preferably, at least a portion 12 of each monitoring channel 11 extends within the portion 13 of the cooling element provided between the first side 7 and the plane 14 defined by the points 15 of the cooling fluid channel system 6 closest to the first side 7. FIGS. 15 to 23 show some embodiments of geometries of providing monitoring channels 11 in the cooling element 4 as seen in the direction of intersection of C-C of FIG. 13 or in the direction of intersection A-A of FIG. 14. It is clear for a person skilled in the art that these are shown to illustrate the great variety of how the monitoring channels 11 may be positioned within the cooling element 4 and that possible embodiments of the geometry of the monitoring channels when seen in this direction is not limited to the embodiments shown in the Figures.

According to an embodiment, such as the embodiments of FIGS. 7 to 10, the monitoring channel system 10 may comprise two or more monitoring channels 11 for pressure medium. According to a further embodiment, in such a monitoring channel system 10, at least a portion 12 of at least some of the monitoring channels 11 may extend in the portion 13 of the cooling element 4 provided between the first side 7 and the plane 14 defined by the points 15 of the cooling fluid channel system 6 closest to the first side 7; and the portions 12 of the monitoring channels extend in a direction parallel to the plane 14, parallel to at least a part of a surface of the first side 7, and/or in a direction provided at an angle of 30 degrees or less, preferably 10 degrees or less, with respect to the plane 14. According to an embodiment, at least some of the monitoring channels 11 are connected to one another by at least one connecting channel 17 provided inside the cooling element to form the monitoring channel system 10. According to an embodiment, at least two of the monitoring channels 11 are connected to one another by at least one connecting channel 17 provided inside the cooling element to form the monitoring channel system 10. According to an embodiment, the connecting channel 17 extends in a direction perpendicular to the monitoring channels, and in a plane parallel to a plane defined by the monitoring channels. According to another embodiment, at least a portion of the connecting channel 17 extends in a direction angled to the monitoring channels, and in a plane angled to a plane defined by the monitoring channels. According to a further embodiment, the angle of the connecting channel with respect to the monitoring channels may be in the range of 5 to 90 degrees, preferably 45 to 90 degrees. According to a further embodiment, the angle of the connecting channel with respect to the plane defined by the monitoring channels is in the range of 0 to 45 degrees, preferably 0 to 20 degrees. According to other embodiments, the connecting channel 17 may connect monitoring channels 11 in some other manner. Some examples are shown in the drawings.

According to an embodiment, at least some of the monitoring channels 11 are connected to one another by at least one connecting channel 17 provided outside the cooling element 4 to form the monitoring channel system 10. According to an embodiment, at least two of the monitoring channels 11 are connected to one another by at least one connecting channel 17 provided outside the cooling element 4 to form the monitoring channel system 10.

According to an embodiment, in a cooling element, wherein the number of the monitoring channels 11 comprising at least a portion 12 of the monitoring channel extending in the portion 13 of the cooling element provided between the first side 7 and a plane 14 defined by the points 15 of the cooling fluid channel system 6 closest to the first side 7, is in the range of 0.2 to 2.0 times the number of the cooling fluid channels 9, preferably 0.8 to 1.5 times and most preferably one monitoring channel per a cooling fluid channel 9, when the cooling element 4 is seen is cross section as in FIGS. 2, 8 and 10, for example.

According to an embodiment, such as according to the embodiments of FIGS. 2 and 8, the cross section 18 of each monitoring channel 11 may overlap with the cross section 19 of a cooling fluid channel 9, when seen from the first side 7 towards the second side 8. According to an embodiment, the cross section 18 of at least one monitoring channel 11 overlaps with the cross section 19 of a cooling fluid channel 9. According to an embodiment, the cross section 18 of at least two or more monitoring channels 11 overlaps in each case with the cross section 19 of a cooling fluid channel 9. According to an embodiment, the cross sections 18 of all the monitoring channels 11 overlap in each case with the cross section 19 of a cooling fluid channel. Depending on the embodiment, the cross section 18 of each monitoring channel 11 overlapping with a cross section 19 of a cooling fluid channel 9 may overlap with a cross section 19 of a cooling fluid channel 9 partly or completely. In other words, the whole cross section 19 of each monitoring channel 11 overlapping with a cross section of a cooling fluid channel 9 may overlap with the cross section 19 of a cooling fluid channel 9, as in the embodiment of FIG. 8, when seen from the direction of the first side 7 towards the second side 8. According to another embodiment, such as according to the embodiment of FIG. 10, the cross section 18 of each monitoring channel 11 does not overlap with the cross section 19 of any one of the cooling fluid channel(s) 9, when seen from the first side 7 towards the second side 8. According to a further embodiment, in a cooling element 4, one or more of the monitoring channels 11 may overlap in each case with a cooling fluid channel 9 and one or more monitoring channels 11 may not overlap with cooling fluid channels 9 as described above, such as in the embodiment of FIG. 12.

According to an embodiment, such as the embodiment of FIG. 10, one or more monitoring channels 11 may be provided in each case within the portion 13 and in the middle of two adjacent cooling liquid channels 9, when seen from the direction of the first side 7 towards the second side 8.

According to an embodiment, such as the embodiment of FIG. 12, monitoring channels 11 may be provided in two or more planes.

It should be understood that two or more monitoring channels 11 shown in the figures may in each case be either connected, even if this was not shown in the figure, and thus form one single monitoring channel 11, or they may be separate monitoring channels 11.

According to an embodiment, the diameter 20 of the monitoring channel 11 is in the range of 6-20 mm, and more preferably in the range of 8-13 mm.

According to an embodiment, each of the monitoring channels 11 is closed at one end and configured to be connected to a pressure medium supply system (not shown) directly or via a connecting channel at a second end.

According to an embodiment, the cooling element 4 further comprises at least one detector 21 connected to the at least one monitoring channel 11 of the monitoring channel system 10 and arranged to detect at least one of the following quantities: pressure in the monitoring channel system, a change in the pressure in the monitoring channel system, flow in the monitoring channel system, or a change in the flow in the monitoring channel system. According to an embodiment, the cooling element 4 comprises exactly one detector 21 connected to the monitoring channel system 10. According to an embodiment, the cooling element 4 comprises exactly one monitoring channel system 10 and exactly one detector 21 connected to the monitoring channel system. According to an embodiment, the detector 21 comprises at least a pressure sensor or a flow meter.

According to an embodiment, in the cooling element 4, each monitoring channel 11 of the monitoring channel system 10 is suitable for the pressure medium having a supply pressure in the range of 0.2 to 10 bar, preferably in the range of 0.4 to 4 bar, and the pressure medium comprising pressurized air, nitrogen or other pressurized gas. In embodiments, where regulation, such as a pressure equipment directive or similar, applies, the supply pressure may be in the range of 0.2 to 0.5 bar.

According to an embodiment, the cooling element 4 is a cooling element suitable for use in a furnace 1 related to a metal production process.

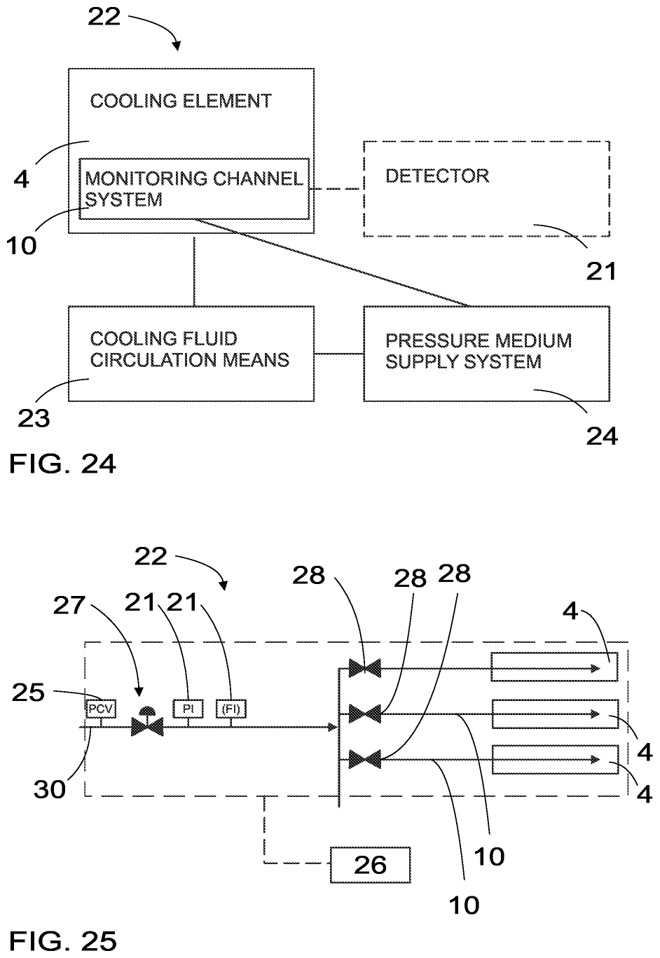

FIG. 24 discloses a cooling arrangement 22 for a furnace 1. FIG. 25 illustrates a detail of a cooling arrangement according to an embodiment.

The cooling arrangement 22 according to FIG. 24 comprises at least one cooling element 4 according to an embodiment disclosed in this description and/or accompanying drawings or a combination of such embodiments. According to the embodiment of FIG. 24, the cooling arrangement 22 further comprises cooling fluid circulation means 23 arranged to circulate cooling fluid in the cooling fluid channel system 6, and pressure medium supply system 24 for providing pressure medium in the monitoring channel system 10 at a predetermined inlet pressure and/or flow.

According to an embodiment, the pressure medium supply system 24 comprises a supply line 30 for the pressure medium, and the supply line 24 for pressure medium is provided with pressure regulating means 25 arranged to reduce the pressure of the supply line 30 to a predetermined value. According to an embodiment, the predetermined value is in the range of 0.2 to 10 bar, preferably in the range of 0.4 to 4 bar. In embodiments, where regulation, such as a pressure equipment directive or similar, applies, the predetermined value may be in the range of 0.2 to 0.5 bar.

According to an embodiment, the cooling arrangement 22 comprises at least one detector 21 according to an embodiment or a combination of embodiments disclosed in connection with the cooling element 4 embodiments. The detector 21 may then be configured to detect the pressure and/or the flow in the monitoring channel system 10. The cooling arrangement may further comprise a monitoring unit 26 for determining whether a predefined condition related to the quantity detected by the detector is met. According to an embodiment, the measured quantity may comprise at least one of the following: pressure in the monitoring channel system and flow in the monitoring channel system. According to an embodiment, the predefined condition comprises at least one of the following: the detected pressure decreasing to a predetermined value or below it, the detected flow increasing to a predetermined value or below it, the detected pressure decreasing by a predefined threshold, or the detected flow increasing by a predefined threshold.

According to an embodiment, the detector 21 is configured to monitor the pressure and/or flow in the monitoring channel system 10 continuously or at predetermined time intervals.

According to an embodiment, the cooling arrangement 22 further comprises flow limiting means 27 provided in the supply line 24 for the pressure medium, and wherein the detector 21 is provided downstream from the flow limiting means 27.

According to an embodiment, at least one of the monitoring channels 11 of the monitoring channel system 10 is provided with a valve 28 capable of opening and closing pressure medium flow in the monitoring channel(s) 11. According to a further embodiment, each monitoring channel 11 of the monitoring channel system 10 is provided with a valve 28 capable of opening and closing pressure medium flow in the monitoring channel. In such embodiments, when an incident is identified in the monitoring channel system 10, its source can be located more precisely. For instance, when a condition related to the quantity detected by the detector is met, the valve(s) may be closed one at a time, and the monitoring channel 11 or a part thereof causing the condition can be located by monitoring measured quantity. More particularly, when the pressure medium flow to the monitoring channel 11 or a part thereof causing the condition is closed by closing the corresponding valve 28, the pressure detected by the detector 21 starts to increase.

According to an embodiment, a cooling arrangement 22 comprises two or more cooling elements 4 and exactly one detector 21. According to an embodiment, one cooling arrangement 22 with one monitoring unit 26 and one detector 21 may be used to monitor two or more cooling elements 4. In such embodiments, the monitoring channels 11 of the cooling elements 4 are connected to each other by a fluid connection.

According to an embodiment, a furnace 1 may comprise at least one cooling element 4 and/or a cooling arrangement 22 according to an embodiment or a combination of embodiments disclosed in this description and/or accompanying drawings. According to an embodiment, the furnace 1 is a furnace related to a metal production process.

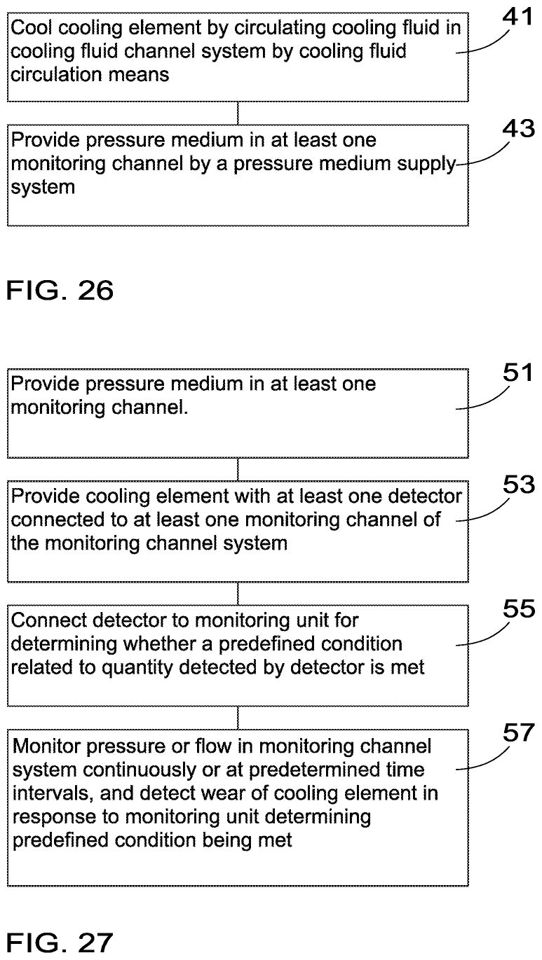

FIG. 26 discloses a method in connection with a cooling element 4 for a furnace 1. The cooling element 4 comprises a cooling element according to an embodiment or a combination of embodiments disclosed in this description and/or the accompanying drawings.

The method according to FIG. 26 comprises cooling 41 the cooling element 4 by circulating cooling fluid in the cooling fluid channel system 6 by cooling fluid circulation means 23; and providing 43 pressure medium in the at least one monitoring channel 11 by a pressure medium supply system. According to an embodiment, the cooling element 4 comprises the at least one detector 21 according to an embodiment or a combination of embodiments disclosed in connection with the cooling element 4 and/or cooling arrangement 22 embodiments; and a monitoring unit 26 for determining whether a predefined condition related to the quantity detected by the detector 21 is met. Thereby, the method may further comprise monitoring pressure or flow in the monitoring channel system 10 continuously or at predetermined time intervals, and detecting wear of the cooling element 4 in response to the monitoring unit determining the predefined condition being met. According to an embodiment, the predefined condition may comprise at least one of the following: the detected pressure decreasing to a predetermined value or below it, the detected flow increasing to a predetermined value or below it, the detected pressure decreasing by a predefined threshold, or the detected flow increasing by a predefined threshold.

According to an embodiment, the cooling element 4 further comprises one or more valves 28 capable of opening and closing pressure medium flow in the monitoring channel(s) 11. According to an embodiment, the valve(s) 28 may be provided in at least one of the monitoring channels 11 of the monitoring channel system 10. The method may, then, further comprise opening and closing the valve(s) 28 one or several at a time to locate the wear causing a drop in the pressure and/or flow in the control system channel.

According to an embodiment, wherein the monitoring unit 26 may be configured to generate a signal causing indication of the wear to an operator.

FIG. 27 discloses a method for monitoring wear of a cooling element 4 for a furnace 1, wherein the cooling element 4 comprises a cooling element according to an embodiment or a combination of embodiments disclosed in this description and/or the accompanying drawings.

The method of FIG. 27 comprises providing 51 pressure medium in the at least one monitoring channel 11; providing 53 the cooling element 4 with the at least one detector 21 connected to the at least one monitoring channel 11 of the monitoring channel system 10; connecting 55 the detector 21 to a monitoring unit 26 for determining whether a predefined condition related to the quantity detected by the detector is met; monitoring 57 pressure or flow in the monitoring channel system 10 continuously or at predetermined time intervals, and detecting wear of the cooling element 4 in response to the monitoring unit determining the predefined condition being met.

1.-36. (canceled)

37. A cooling element for a furnace, the cooling element comprising:
a first side configured to be directed towards the inside of the furnace,
a second side opposite to the first side and configured to be directed away from the inside of the furnace,
a cooling fluid channel system for cooling fluid circulation, the cooling fluid channel system comprising at least one cooling fluid channel provided inside the cooling element, wherein
the cooling element further comprises a monitoring channel system comprising at least one monitoring channel for pressure medium, at least a portion of the monitoring channel extending in the portion of the cooling element provided between the first side and a plane defined by the points of the cooling fluid channel system closest to the first side,
wherein said portion of the monitoring channel extends in at least one of the following directions: in a direction parallel to said plane, in a direction parallel to at least a part of a surface of the first side, or in a direction provided at an angle of 30 degrees or less with respect to said plane.

38. The cooling element according to claim 37, wherein the cooling element comprises two or more cooling fluid channels.

39. The cooling element according to claim 37, wherein the monitoring channel system comprises two or more monitoring channels for pressure medium, at least a portion of at least some of said monitoring channels extending in the portion of the cooling element provided between the first side and the plane defined by the points of the cooling fluid channel system closest to the first side, and wherein said portions of the monitoring channels extend in at least one of the following directions: in a direction parallel to said plane, parallel to at least a part of a surface of the first side, or in a direction provided at an angle of 30 degrees or less with respect to said plane.

40. The cooling element according to claim 39, wherein at least some of said monitoring channels are connected to one another by at least one connecting channel provided inside the cooling element or outside the cooling element to form the monitoring channel system.

41. The cooling element according to claim 37, wherein the number of the monitoring channels comprising at least a portion of the monitoring channel extending in the portion of the cooling element provided between the first side and a plane defined by the points of the cooling fluid channel system closest to the first side, is in the range of 0.2 to 2.0 times the number of the cooling fluid channels.

42. The cooling element according to claim 37, wherein the diameter of the monitoring channel is in the range of 6-20 mm.

43. The cooling element according to claim 37, wherein each of the monitoring channels is closed at one end and configured to be connected to a pressure medium supply system directly or via a connecting channel at a second end.

44. The cooling element according to claim 37, wherein the cooling element further comprises at least one detector connected to the at least one monitoring channel of the monitoring channel system and arranged to detect at least one of the following quantities: pressure in the monitoring channel system, a change in the pressure in the monitoring channel system, flow in the monitoring channel system, or a change in the flow in the monitoring channel system.

45. The cooling element according to claim 44, wherein the cooling element comprises exactly one detector connected to the monitoring channel system.

46. The cooling element according to claim 37, wherein each monitoring channel of the monitoring channel system is suitable for the pressure medium having a supply pressure in the range of 0.2 to 10 bar and the pressure medium comprising pressurized air, nitrogen or other pressurized gas.

47. The cooling arrangement for a furnace, wherein the cooling arrangement comprises:
at least one cooling element according to claim 37,
cooling fluid circulation means arranged to circulate cooling fluid in the cooling fluid channel system, and
pressure medium supply system for providing pressure medium in the monitoring channel system at least at one of the following: at a predetermined inlet pressure and flow.

48. The cooling arrangement according to claim 47, wherein the pressure medium supply system comprises a supply line for the pressure medium, and the supply line for pressure medium is provided with pressure regulating means arranged to reduce the pressure of the supply line to a predetermined value, which predetermined value is in the range of 0.2 to 10 bar.

49. The cooling arrangement for a furnace, wherein the cooling arrangement comprises:
at least one cooling element for a furnace comprising:
a first side configured to be directed towards the inside of the furnace,
a second side opposite to the first side and configured to be directed away from the inside of the furnace,
a cooling fluid channel system for cooling fluid circulation, the cooling fluid channel system comprising at least one cooling fluid channel provided inside the cooling element, wherein
the cooling element further comprises a monitoring channel system comprising at least one monitoring channel for pressure medium, at least a portion of the monitoring channel extending in the portion of the cooling element provided between the first side and a plane defined by the points of the cooling fluid channel system closest to the first side,
wherein said portion of the monitoring channel extends in at least one of the following directions: in a direction parallel to said plane, in a direction parallel to at least a part of a surface of the first side, or in a direction provided at an angle of 30 degrees or less with respect to said plane,
wherein the cooling arrangement comprises at least one detector according to claim 44 configured to detect at least one of the following: the pressure or the flow in the monitoring channel system, and
a monitoring unit for determining whether a predefined condition related to the quantity detected by the detector is met,
wherein the measured quantity comprises at least one of the following: pressure in the monitoring channel system and flow in the monitoring channel system.

50. The furnace comprising at least one of the following: at least one cooling element for a furnace, the at least one cooling element comprising:
a first side configured to be directed towards the inside of the furnace,
a second side opposite to the first side and configured to be directed away from the inside of the furnace,
a cooling fluid channel system for cooling fluid circulation, the cooling fluid channel system comprising at least one cooling fluid channel provided inside the cooling element, wherein
the cooling element further comprises a monitoring channel system comprising at least one monitoring channel for pressure medium, at least a portion of the monitoring channel extending in the portion of the cooling element provided between the first side and a plane defined by the points of the cooling fluid channel system closest to the first side,
wherein said portion of the monitoring channel extends in at least one of the following directions: in a direction parallel to said plane, in a direction parallel to at least a part of a surface of the first side, or in a direction provided at an angle of 30 degrees or less with respect to said plane, or
a cooling arrangement according to claim 47.

51. The furnace according to claim 50, wherein the furnace is a furnace related to a metal production process.

52. The method in connection with a cooling element for a furnace, wherein the cooling element comprises a cooling element according to claim 37,
wherein the method comprises:
cooling the cooling element by circulating cooling fluid in the cooling fluid channel system by cooling fluid circulation means; and
providing pressure medium in the at least one monitoring channel by a pressure medium supply system.

53. The method in connection with a cooling element for a furnace, wherein the cooling element comprises a cooling element for a furnace, the cooling element comprising:
a first side configured to be directed towards the inside of the furnace,
a second side opposite to the first side and configured to be directed away from the inside of the furnace,
a cooling fluid channel system for cooling fluid circulation, the cooling fluid channel system comprising at least one cooling fluid channel provided inside the cooling element, wherein
the cooling element further comprises a monitoring channel system comprising at least one monitoring channel for pressure medium, at least a portion of the monitoring channel extending in the portion of the cooling element provided between the first side and a plane defined by the points of the cooling fluid channel system closest to the first side,
wherein said portion of the monitoring channel extends in at least one of the following directions: in a direction parallel to said plane, in a direction parallel to at least a part of a surface of the first side, or in a direction provided at an angle of 30 degrees or less with respect to said plane,
wherein the method comprises:
cooling the cooling element by circulating cooling fluid in the cooling fluid channel system by cooling fluid circulation means; and
providing pressure medium in the at least one monitoring channel by a pressure medium supply system.
wherein the cooling element comprises:
the at least one detector according to claim 44, and
a monitoring unit for determining whether a predefined condition related to the quantity detected by the detector is met,
and the method further comprises:
monitoring pressure or flow in the monitoring channel system continuously or at predetermined time intervals, and
detecting wear of the cooling element in response to the monitoring unit determining the predefined condition being met.

54. The method according to claim 37, wherein the predefined condition comprises at least one of the following: the detected pressure decreasing to a predetermined value or below it, the detected flow increasing to a predetermined value or below it, the detected pressure decreasing by a predefined threshold, or the detected flow increasing by a predefined threshold.

55. The method according to claim 52, wherein the cooling element further comprises valves capable of opening and closing pressure medium flow in said monitoring channel(s) provided in at least one of the monitoring channels of the monitoring channel system, and
wherein the method further comprises opening and closing said valve(s) one or several at a time to locate the wear causing a drop in at least one of the following: in the pressure or flow in the control system channel.

56. The method for monitoring wear of a cooling element for a furnace, wherein the cooling element comprises a cooling element according to claim 37,
wherein the method comprising:
providing pressure medium in the at least one monitoring channel;
providing the cooling element with the at least one detector connected to the at least one monitoring channel of the monitoring channel system;
connecting the detector to a monitoring unit for determining whether a predefined condition related to the quantity detected by the detector is met,
monitoring pressure or flow in the monitoring channel system continuously or at predetermined time intervals, and
detecting wear of the cooling element in response to the monitoring unit determining the predefined condition being met.
